(19) United States
(12) Patent Application Publication
(10) Pub. No.: US 2018/0164265 A1
(43) Pub. Date: Jun. 14, 2018

(54) TIME MEASURING DEVICE

(71) Applicant: ACOMM GMBH, Hamburg (DE)

(72) Inventor: CHRISTIAN LIEB, BAD STAFFELSTEIN (DE)

(21) Appl. No.: 15/579,290

(22) PCT Filed: May 19, 2016
(86) PCT No.: PCT/EP2016/061301

§ 371 Date: Dec. 4, 2017

(30) Foreign Application Priority Data
Jun. 5, 2015 (DE) 102015108921.1

(51) Int. Cl. G01N 31/22

(52) U.S. Cl. CPC G01N 31/229; A47J 31/52

(57) ABSTRACT

Provided is a time measuring device, including a strip of absorbent material, which is sheathed by an air-tight material, wherein the sheath includes in the lower half at least one hole, and wherein a dye is applied on up to 90% of the surface of the strip. Embodiments of the invention also relate to a method for the use thereof.

### CROSS-REFERENCE TO RELATED APPLICATIONS

This application claims priority to PCT Application No. PCT/EP2016/061301, having a filing date of May 19, 2016, based on DE 10 2015 108 921.1, having a filing date of Jun. 5, 2015, the entire contents both of which are hereby incorporated by reference.

### FIELD OF TECHNOLOGY

The following relates to a time measuring device, a tea packaging and a method of using it.

### BACKGROUND

If you want to prepare tea, the infusion time, during which the freshly brewed tea infuses before the tea leaves or other plant extract is removed from the water, is crucial. The tea leaves are often packed in tea bags. This time has traditionally been measured with a clock or an alarm clock. The disadvantage of this is, on the one hand, that a clock or an alarm clock is quite expensive and can be stolen. On the other hand, the user must know the optimum time for the tea, he wants to drink, to infuse.

### SUMMARY

An aspect relates to a time measuring device that is inexpensive and conveniently indicates the duration, during which the tea must infuse.

The task underlying embodiments of the invention is solved in a first embodiment by a time measuring device, characterized in that it comprises a strip of absorbent material sheathed with an airtight material, wherein the sheath has at least one hole in the lower half thereof, and wherein a dye is applied to up to 90% of the surface of said strip.

If, for example, such a strip is inserted with the lower end into a freshly brewed tea cup, the tea is absorbed through the hole by the strip and the tea moves upwards in the strip by capillary forces. In doing so, the tea either takes a dye applied for example in the vicinity of the hole with it on its way or, for example, by means of its pH value, the tea changes the colour of a pH indicator dye previously applied at a certain point. In any case, the user can easily follow the tea's ascent height by means of the dye. For example, if a very specific tea must infuse for 5 minutes, a mark is placed, for example, at the height that the tea has reached in 5 minutes, so that the user can easily recognize that the tea has infused for 5 minutes. Then, the user can remove the strip and the tea bag and is sure that he has prepared an optimally infused tea. Of course, this explanation does not limit the scope of protection of the claims. There are also many other applications, such as measuring the duration of an egg boiling.

Preferably, the time measuring device according to embodiments of the present invention is suitable for a liquid to rise in the strip within a predetermined and repeatable time to a preferentially marked target area as soon as the liquid comes into contact with the hole in the time measuring device.

In contrast to the state of the art, the time measuring device according to embodiments of the invention must only be suitable for displaying a time or a duration. The time measuring device according to embodiments of the invention does not have to be suitable for performing chemical analyses. The inventive time measuring device is preferably suitable for use in a freshly brewed cup of tea.

### I. Time Measuring Device

The length of the time measuring device according to embodiments of the invention is preferably between 5 cm and 20 cm. If the length is below this length, the time measuring device becomes too inaccurate. If the length is longer than this, a very thick strip is required and cannot be packed so easily into a tea packaging. The width of the time measuring device according to embodiments of the invention is preferably in a range from 0.1 to 6 cm. If the width is below this range, it is difficult to apply the hole and the user has difficulties in reading the time. The thickness (depth) of the time measuring device according to embodiments of the invention lies preferably in a range from 0.001 to 0.2 cm.

### II. Strip

The length of the strip according to embodiments of the invention is preferably between 5 and 20 cm. If the length is below this length, the time measuring device becomes too inaccurate. If the length is longer than this, a very thick strip is required, and it cannot be packed so easily. The width of the strip according to embodiments of the invention lies preferably in a range from 0.1 to 6 cm. If the width is below this range, it is difficult to apply the hole and the user has difficulties in reading the time. The thickness (depth) of the strip according to embodiments of the invention lies preferably in a range from 0.001 to 0.2 cm.

The strip can be bent, for example. The strip can also be available as a spiral. For example, the sheath can have a rectangular shape, within which the strip is formed as a flat spiral. The sheath can be removed in the space between the individual spiral or have incisions. This has the advantage that the dimension of the time measuring device can be adapted to existing packaging forms such as tea bags, tea filters or disposable packaging of tea bags. The strip of the time measuring device according to embodiments of the invention can preferably have any geometric shape, in which the aspect ratio of length to width is in a range from 1.2:1 to 2000:1, and in particular in a range from 2:1 to 1000:1. It can be oval or rectangular, for example. Particularly preferably, the strip of the time measuring device according to embodiments of the invention has the shape of a cuboid or rectangle. This has the special advantage that the strip can be dipped into a cup of tea, for example, and that part of the strip can protrude from the liquid, so that the strip can be easily removed after use.

The absorbent material is preferably a non-woven fabric or a paper, especially preferably blotting paper.

The content of liquids in the strip according to embodiments of the invention is preferably no more than 1% by weight. The strip in accordance with embodiments of the invention is particularly preferred to be dry, i.e. it does not contain any liquids.

Preferably, at least one visible mark is applied to the strip and/or the time measuring device. This mark can preferably indicate a predetermined duration. The mark preferably corresponds to the ascent height of the tea in the strip, which is reached when the employed tea has infused for the optimum time.

Alternatively, the at least one visible mark can also indicate a time in minutes and/or seconds. For example, a time scale can be displayed. Preferably, several marks can be applied to the strip. These multiple marks can, for example, display several minutes. This makes the time measuring device according to embodiments of the invention universally applicable for different kinds of tea or other applications. The strip preferably has a total weight in a range of 10 to 70% by weight of the time measuring device.

The edges of the strip do not have to be continuous. The edges of the strip may also have indentations, for example.

### III. Sheath

The thickness of the sheath according to embodiments of the invention lies preferably in a range from 0.01 to 1 mm.

The hole in the sheath should preferably not be located at the edge of the strip and preferably has a minimum distance of 1 mm, especially preferably at least 2 mm, from the edge of the strip. This prevents, for example, the tea from rising faster at the edge of the strip in a possibly existing gap between the sheath and the strip than in the rest of the strip.

The hole in the sheath of the time measuring device according to embodiments of the invention preferably has a distance of 1 to 20 mm from the lower edge of the time measuring device according to embodiments of the invention. Independently, the hole in the sheath of the time measuring device according to embodiments of the invention preferably has a distance of 1 to 20 percent of the length of the time measuring device from the lower edge of the time measuring device according to embodiments of the invention.

The size of the at least one hole is preferably in a range from 0.05 to 1 percent of the surface of the sheath. The total hole area of all holes is preferably in a range from 0.07 to 5 percent, in particular preferably in a range from 1 to 3 percent, of the surface of the sheath.

The at least one hole is preferably located in the lower half of the sheath. Preferably, there are no holes in the upper half of the sheath of the time measuring device according to embodiments of the invention.

In principle, the hole can have any geometric shape, such as a circle. Preferably, the sheath has exactly one hole.

The time measuring device according to embodiments of the invention preferably has no spacer. The disadvantage of a spacer is that the spacer can create a gap between the strip and the sheath, which has a negative effect on the ascent behaviour.

Preferably, the hole in the sheath has no cover that would have to be removed before use. Alternatively, the hole can also be covered. The cover may be temporary so that it can be removed before use. The time measuring device can preferably be wrapped with a jacket made of a plastic foil, for example, in addition to the sheath. This has the advantage that hygienic protection can be guaranteed during transport before use.

The sheath is preferably transparent at least on the front side of the sheath and preferably not printed.

The sheath consists preferably of a plastic approved for foodstuffs and/or food-safe plastic. Particularly preferably, the sheath consists of cellulose, polystyrene or melamine resin.

The sheath preferably has a total weight in a range of 10 to 70% by weight of the time measuring device.

The weight ratio between strip and sheath is preferably in a range from 4:1 to 1:4.

### IV. Dye

The dye according to embodiments of the invention can be a dye visible to the human eye but also a dye that is not initially visible to the human eye, that only becomes visible upon contact with another substance such as the ascending tea. For example, it can be a pH indicator dye.

Preferably, the inventive time measuring device comprises only one single dye. A single dye is completely sufficient to display the time. The fewer dyes are used, the easier it is to obtain approval for foodstuffs. The dye is particularly preferably a food colouring agent.

The dye is preferably water soluble. This has the advantage that it can be transported with the ascending tea within the strip.

The retention factor (Rf-value, also retarding front or relate to front) of the dye in water is preferably in a range from 0.8 to 1. This has the special advantage that a clear line of the dye is visible when the tea ascends. The dye is preferably hydrophilic. Regardless of this, the dye is preferably available as alkali salt or alkaline earth salt.

Preferably, the dye is an azo dye, especially preferably selected from azorubine (E122), cochineal red A (E124) or allura red AC (E129). Preferably, the dye is visible to the human eye without auxiliary agents (such as ultraviolet light). The dye is preferably applied only to the lower half of the strip or only to the upper half of the strip.

The dye is preferably applied only on up to 50% of the strip surface, especially preferably only on up to 10% of the strip surface, in particular preferably only on up to 5% of the strip surface.

The dye is preferably applied only to the front of the strip.

Preferably, the dye is applied to the front side of the strip in a range from 1 to 10% of the surface of the front side of the strip.

Preferably, the dye is applied to the strip at the height of the hole in the sheath or above the hole in the sheath. The dye is preferably applied within the lower 20% (relative to the length of the strip), especially preferably within the lower 10% of the strip. Particularly preferably, in the upper 20% of the strip, more preferably in the upper 80% of the strip, no dye is applied to the strip. As a result, the tea ascending by capillary forces can transport the dye upwards in the strip, and thus the dye indicates the ascent height of the tea in the strip. When reaching a certain height, for example, a mark may be placed on the strip indicating to the user that the tea has infused for a predetermined time. Preferably the dye is placed on the strip with a distance of at least 1 mm, especially preferably 2 mm from the edge of the strip.

For example, the dye can be a pH indicator such as litmus. If the dye is a pH-indicator, then the dye is preferably applied in the upper 70%, especially preferably in the upper half of the strip. In particular, the mark indicating the end of the time the tea has to infuse is marked on the strip with this dye. If, for example, the time measuring device according to embodiments of the invention is put with the lower end into a freshly brewed tea, the tea reaches the absorbent material through the hole. Due to the capillary forces, for example, the liquid of the tea moves upwards in the strip. This takes some time. Each tea has a certain duration during that it must infuse optimally. The strip is therefore preferably marked at the height of the strip that corresponds to the optimum time, for example with the dye and in particular the pH indicator. As the tea is acidic, the colour of the mark changes when the mark is reached, and the user can see that the optimum time has been reached.

Preferably, the inventive time measuring device comprises dye in a range from 0.0001 to 1% by weight, particularly preferably in a range from 0.0001 to 0.05% by weight.

### V. General Features

The content of further reagents or auxiliary reagents other than the dye or dyes is preferably less than 1% by weight. Preferably, the time measuring device according to the invention has no reagents or auxiliary reagents other than the dye or dyes. It is possible to determine the time without these additional reagents. Furthermore, the low content of other reagents facilitates approval in the food sector.

In particular, the time measuring device according to embodiments of the invention does not contain any alcohol, in particular no ethyl alcohol. Preferably, all components of the time measuring device according to embodiments of the invention are food-safe and/or approved for contact with foodstuffs.

The inventive time measuring device preferably has no ion exchangers.

The innovative time measuring device can also be integrated in a tea bag, tea filter or even in a package of a tea bag.

The inventive time measuring device can preferably be flexible. In particular, the inventive time measuring device can replace the string in tea bags.

### VI. Tea Packaging

In a further embodiment, the task underlying embodiments of the invention is solved by tea packaging, comprising at least one time measuring device according to embodiments of the invention.

A tea packaging in the sense of embodiments of the invention can be a tea bag, a tea filter or a stick or a cardboard box or a bag or a box for tea bags.

### VII. Method

In a further embodiment, the task underlying the invention is solved by a method of time measurement, characterised in that the time measuring device according to the invention is immersed in a liquid with the lower end.

Preferably, the time measuring device is immersed in the liquid in such a way that at least 10% of the length of the time measuring device at its upper end protrudes from the liquid. It is preferable that the time measuring device according to embodiments of the invention is immersed in the liquid during the method to a maximum of 90%, in particular preferably to a maximum of 70% of its total surface area. This makes it easier to remove the time measuring device according to embodiments of the invention from the tea.

The ascent height indicated by the dye can also be read below the surface of the liquid, for example.

Preferably, at least one dye of the time measuring device according to embodiments of the invention is preferably transported by the ascending liquid within the strip.

In the method according to embodiments of the invention, the absorbent material is preferably not completely wetted with the liquid at the beginning of the method. Otherwise, for example, the liquid such as tea could not rise within the strip and transport the dye, for example.

In the method according to embodiments of the invention, the direction of flow of the liquid is preferably from the lower end of the strip to the upper end of the strip, i.e. exactly one fixed direction of flow.

The capillary fluid flow of the liquid such as tea, for example, is preferably not stopped or interrupted during the method according to embodiments of the invention.

The liquid preferably has a water content in a range of 95 to 100% by weight, especially in a range of 99 to 100% by weight.

Preferably, the liquid is freshly brewed tea.

### BRIEF DESCRIPTION

Some of the embodiments will be described in detail, with reference to the following figures, wherein like designations denote like members, wherein:

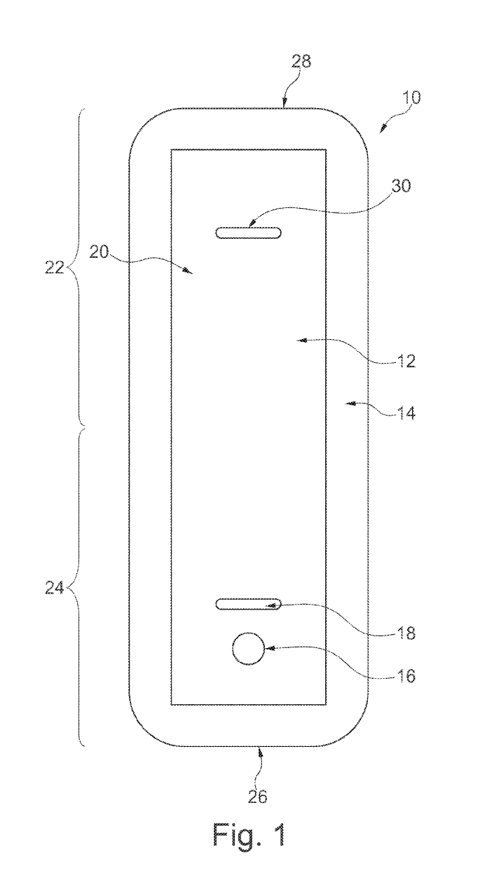

FIG. 1 shows a plan view of the time measuring device according to embodiment of the invention; and

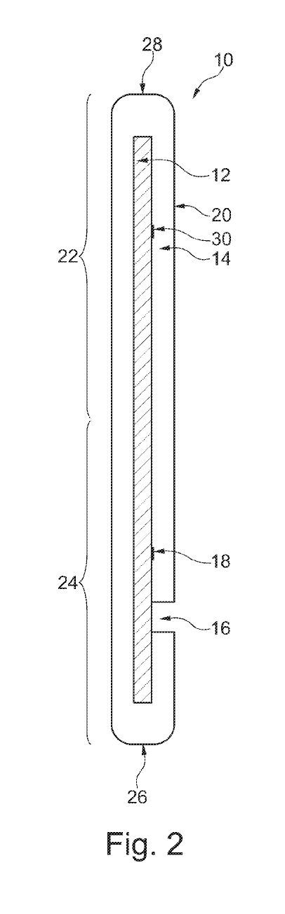

FIG. 2 shows a side view of the inventive time measuring device.

### DETAILED DESCRIPTION

In FIG. 1 one sees the time measuring device 10, wherein a strip 12 is wrapped with a sheath 14. The sheath 14 has a hole 16 in the lower half 24, through which tea, for example, can get onto strip 12 and then ascend in the strip 12. The tea can then take at least a part of the dye 18 applied in the lower half 24 along its way, which is caused by capillary forces, up towards the upper half 22. As soon as the tea with the dye 18 has reached the mark 30, the user knows that the tea has infused during the optimum time and can remove the tea bag and the time measuring device from the cup.

### VIII. Example

0.1 ml of azorubine dye was applied to a strip of standard blotting paper measuring 1×15 cm in the middle of the strip at a distance of 2 cm from the lower end of the strip. The strip was then laminated into 0.5 mm thick polystyrene foil, into which a circular hole of 4 mm size was punched in a way that the hole was arranged in the middle of the strip and 1 cm from the lower end. The strip had previously been marked with a pencil about 2 cm from the upper end. Afterwards, a cup of tea was brewed with peppermint tea and upon dipping of the tea bag, the time measuring device was also dipped into the cup with the bottom end, so that the upper end was sticking out of the tea liquid. The tea was absorbed through the hole by the blotting paper and was transported by capillary forces through the blotting paper upwards towards the upper end of the time measuring device. At the same time, the azorubine dye was dissolved in the tea and transported in the same direction. At some point, the azorubine dye reached the pencil mark and the tea bag and the time measuring device were removed from the cup of tea.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

### REFERENCE SIGNS

10 time measuring device
12 strip
14 sheath
16 hole
18 dye
20 front side
22 upper half
24 lower half
26 lower end
28 upper end
30 mark

1-10. (canceled)

11. A time measuring device, comprising a strip of absorbent material, wherein a dye is applied to up to 90% of the surface of said strip,
wherein
a. the strip is sheathed with an airtight material;
b. the sheath has at least one hole for tea to enter the strip in a lower half to be inserted into the tea; and
c. the time measuring device has exactly one fixed direction of liquid flow from the lower end of the strip towards the upper end of the strip.

12. The time measuring device according to claim 11,
wherein
the time measuring device comprises at least one means for a liquid to rise in the strip within a predetermined and repeatable time to a preferentially marked target area as soon as the liquid comes into contact with the hole.

13. The time measuring device according to claim 11,
wherein
a. the hole is arranged on a flat side of the strip;
b. the hole is arranged horizontally centrally on a flat side of the strip; and/or
c. the dye is applied above the hole and preferably a mark is applied above the dye to the strip.

14. The time measuring device according to claim 11,
wherein
a. the at least one hole is not located at the edge of the strip and preferably has a minimum distance of 1 mm, especially preferably at least 2 mm, from the edge of the strip;
b. the dye is placed on the strip with a distance of at least 1 mm, especially preferably 2 mm from the edge of the strip;
c. the time measuring device has no spacer between the strip and the sheath.

15. The time measuring device according to claim 11,
wherein the dye
a. is not initially visible to the human eye and becoming visible upon contact with another substance;
b. has a retention factor of the dye in water on the strip in a range from 0.8 to 1 and/or
c. is a pH indicator applied in the upper 70% of the strip and/or marking a mark indicating the end of the time a tea has to infuse.

16. The time measuring device according to claim 11,
wherein
a. the dye is a food colouring agent,
b. the time measuring device comprises only one single dye;
c. the time measuring device comprises less than 1% by weight of further reagents or auxiliary reagents other than the dye or dyes, preferably no further reagents or auxiliary reagents; and/or
d. the sheath comprises a food-safe plastic.

17. The time measuring device according to claim 11,
wherein
a. the dye is applied only on up to 50% of the strip surface;
b. the dye is applied only to the front side of the strip;
c. the dye is applied within the lower 20%;
d. the sheath is preferably transparent at least on the front side of the sheath; and/or
e. the ascent height indicated by the dye can also be read below the surface of the liquid.

18. The time measuring device according to claim 11,
wherein
a. the hole has a, preferably temporary, cover; and/or
b. the time measuring device is wrapped with a jacket, preferably made of a plastic foil, in addition to the sheath.

19. The Time measuring device according to claim 11,
wherein
a. the strip is made of standard blotting paper measuring 1×15 cm;
b. 0.1 ml of azorubine dye is applied to the strip in the middle of the strip at a distance of 2 cm from the lower end of the strip;
c. the strip is laminated into 0.5 mm thick polystyrene foil;
d. the polystyrene foil comprises a circular hole of 4 mm size in the middle of the strip and 1 cm from the lower end of the strip; and
e. the strip is marked with a pencil about 2 cm from the upper end of the strip.

20. A tea packaging comprising at least one time measuring device according to claim 11.

21. A method of time measurement,
wherein
the time measuring device according to claim 11 is immersed in a liquid with the lower end thereof

22. The time measuring device according to claim 16,
wherein the food colouring agent, is an azo dye, selected from azorubine (E122), cochineal red A (E124) and allura red AC (E129).
